(19) United States
(12) Patent Application Publication
(10) Pub. No.: US 2017/0142477 A1
(43) Pub. Date: May 18, 2017

(54) Method, Device, Server And Terminal Equipment For Cross-screen Interaction

(71) Applicants: Le Holdings (Beijing) Co., Ltd., Beijing (CN); Le Shi Internet Information Technology Corp. Beijing, Beijing (CN)

(72) Inventor: Yan Liu, Beijing (CN)

(21) Appl. No.: 15/247,356

(22) Filed: Aug. 25, 2016

Related U.S. Application Data
(63) Continuation of application No. PCT/CN2016/082634, filed on May 19, 2016.

(30) Foreign Application Priority Data
Nov. 16, 2015 (CN) 201510784607.8
May 19, 2016 (CN) PCT/CN2016/082634

(51) Int. Cl. H04N 21/439; H04N 21/4402; H04N 21/488; H04N 21/235; H04N 21/2383

(52) U.S. Cl. CPC H04N 21/4398; H04N 21/2351; H04N 21/2383; H04N 21/4882; H04N 21/440245; H04N 21/812

(57) ABSTRACT

The present application discloses a method, a device, a server and a terminal equipment for cross-screen interaction. The method includes: performing coding and modulation on an interaction content identity to generate a first audio signal imperceptible to human hearing; superposing the first audio signal and a second audio signal of a video content, and sending the video content with audio superposition to a display device to play; and receiving the code of the interaction content identity sent by a terminal equipment after detecting the first audio signal, sending the interaction content corresponding to the code to the terminal equipment, and displaying the interaction content by the terminal equipment.

### CROSS-REFERENCE TO RELATED APPLICATIONS

This application is a continuation of International Application No. PCT/CN2016/082634, filed on May 19, 2016, which is based upon and claims priority to Chinese Patent Application No. 201510784607.8, filed on Nov. 16, 2015, the entire contents of all of which are incorporated herein by reference.

### TECHNOLOGY FIELD

The present disclosure herein generally related to internet, and particularly related to a method, a device, a server and a terminal equipment for cross-screen interaction.

### BACKGROUND

Viewing online video contents through a video application becomes an important part of people's working, studying, entertainment and daily life with the popularization of internet multimedia technologies.

The current video advertisement interaction technology usually is that playing corresponding advertisement interaction information before playing the video, or displaying the advertisement interaction information at a corner of the video interface while playing the video. A third-party client browser starts and accesses a predetermined information page when the advertisement interaction information is clicked by users. Because the starting of the third-party client software, which needs operations such as initialization etc., is necessary for the above processing, the costs of CPU and memory resources would lower the response speed of video player terminal. And the advertisement interaction information displayed at corners may cause negative influence on the experience of video contents watching.

In a word, the advertisement interaction information of videos is concentrated on the side of the video player terminal at present. The video viewing of would be distracted usually when the user participates in the corresponding advertisement interaction. And it reduces the users' will of interaction.

### SUMMARY

In light of this, the present disclosure provides a method, a device, a server and a terminal equipment for cross-screen interaction, for solving the technical problem in the prior art that the advertisement interaction information of videos is concentrated on the side of the video player terminal, which reduces the will of the user to participate in the interaction.

In order to solve the foregoing technical problem, the embodiments of the present disclosure disclose a method for cross-screen interaction, including: at an electronic device: performing coding and modulation on an interaction content identity to generate a first audio signal imperceptible to human hearing; superposing the first audio signal and a second audio signal of a video content, and sending the video content with audio superposition to a display device to play; and receiving the code of the interaction content identity sent by a terminal equipment after detecting the first audio signal, sending the interaction content corresponding to the code to the terminal equipment, and displaying the interaction content by the terminal equipment.

In order to solve the foregoing technical problem, the embodiments of the present disclosure also disclose a method for cross-screen interaction, including: at an electronic device: collecting an audio of a video content played by a display device, the audio including a second audio signal of the video content and a first audio signal imperceptible to human hearing; when the first audio signal is collected, demodulating the code of a corresponding interaction content identity according to the first audio signal and sending the code to a server, and acquiring the corresponding interaction content according to the code from the server; and receiving the interaction content from the server and displaying the interaction content.

In order to solve the foregoing technical problem, the embodiments of the present disclosure also disclose a device for cross-screen interaction, including: one or more processors; and a first memory configured to store instructions which is executable for the one or more processors; wherein, the one or more processors are configured to: perform coding and modulation on an interaction content identity to generate a first audio signal imperceptible to human hearing; superpose the first audio signal and a second audio signal of a video content, and send the video content with audio superposition to a display device to play; and receive the code of the interaction content identity sent by a terminal equipment after detecting the first audio signal, send the interaction content corresponding to the code to the terminal equipment, and display the interaction content by the terminal equipment.

In order to solve the foregoing technical problem, the embodiments of the present disclosure also disclose a device for cross-screen interaction, including: one or more processors; and a second memory configured to store instructions which is executable for the one or more processors; wherein, the one or more processors are configured to: collect an audio of a video content played by a display device, the audio including a second audio signal of the video content and a first audio signal imperceptible to human hearing, and the first audio signal being superposed on the second audio signal according with a preset interaction time period; when the first audio signal in the audio is acquired, demodulate the code of a corresponding interaction content identity according to the first audio signal and send the code to a server, and acquire the corresponding interaction content according to the code from the server; and receive the interaction content from the server and display the interaction content.

In order to solve the foregoing technical problem, the embodiments of the present disclosure also disclose a server, including: one or more processors; and a first memory configured to store instructions which is executable for the one or more processors; wherein, the one or more processors are configured to: perform coding and modulation on an interaction content identity to generate a first audio signal imperceptible to human hearing; superpose the first audio signal and a second audio signal of a video content, and send the video content with audio superposition to a display device to play; and receive the code of the interaction content identity sent by a terminal equipment after detecting the first audio signal, send the interaction content corresponding to the code to the terminal equipment, and display the interaction content by the terminal equipment.

In order to solve the foregoing technical problem, the embodiments of the present disclosure also disclose a terminal equipment, including: one or more processors; and a second memory configured to store instructions which is executable for the one or more processors; wherein, the one or more processors are configured to: collect an audio of a video content played by a display device, the audio including a second audio signal of the video content and a first audio signal imperceptible to human hearing; when the first audio signal is collected, demodulate the code of a corresponding interaction content identity according to the first audio signal and sending the code to a server, and acquire the corresponding interaction content according to the code from the server; and receive the interaction content from the server and display the interaction content.

Compared with the prior art, the method, the device, the server and the terminal equipment for cross-screen interaction provided by the embodiments of the present disclosure perform coding and modulation on the interaction content identity to generate the first audio signal imperceptible to human hearing, and superpose the first audio signal in the second audio signal; when the display device plays the video content, the terminal equipment collects the first audio signal and demodulates the code of the interaction content identity, then the server sends the interaction content corresponding to the code to the terminal equipment to display; when a user is viewing the video played by the display device, the superposed first audio signal will not be perceived, so that the user's viewing will not be distracted; displaying the interaction content by the terminal equipment implements the separation the interaction content from the video content, so that the interaction content will not occupy the resources of the display device and will not distract the appreciation of the user on the video content, which contributes to improving the will and motivation of the user's participating in the interaction, and is more participatory and interesting.

### BRIEF DESCRIPTION OF THE DRAWINGS

In order to explain the technical solutions in the embodiments of the disclosure or in the prior art more clearly, the figures used for descripting the embodiments or the prior art will be simply introduced hereinafter. It is apparent that the figures described hereinafter are merely some embodiments of the disclosure, and those skilled people in the art may also obtain other figures according to these figures without creative work.

FIG. 1 is a flow chart of a method for cross-screen interaction of the embodiments of the present disclosure;

FIG. 2 is a flow chart of the method for cross-screen interaction of the embodiments of the present disclosure;

FIG. 3 is a flow chart of the method for cross-screen interaction of the embodiments of the present disclosure;

FIG. 4 is a block diagram of a system for cross-screen interaction of the embodiments of the present disclosure;

FIG. 5 is a flow chart of the method for cross-screen interaction of the embodiments of the present disclosure;

FIG. 6 is a block diagram of a device for cross-screen interaction of the embodiments of the present disclosure;

FIG. 7 is a block diagram of the device for cross-screen interaction of the embodiments of the present disclosure; and

FIG. 8 is a block diagram of the device for cross-screen interaction of the embodiments of the present disclosure.

FIG. 9 is a block diagram of a server of the embodiments of the present disclosure.

FIG. 10 is a block diagram of a terminal equipment of the embodiments of the present disclosure.

FIG. 11 is a block diagram of a terminal equipment of the embodiments of the present disclosure.

### DETAILED DECRIPTION

To explain the objects, technical solutions and advantages of the embodiments of the present disclosure more clearly, the technical solutions of the present disclosure will be clearly and completely described hereinafter with the embodiments and figures of the present disclosure. Apparently, the embodiments described are merely part of the embodiments in the present disclosure, rather than all embodiments. Based on the embodiments of the disclosure, any other embodiments can be derived by those skilled people in the art without creative efforts shall be considered as in the protection scope of the present disclosure.

The embodiments of the present disclosure convert the interaction content identity into a high frequency audio (the frequency is higher than 20 KHz) imperceptible to human hearing through coding and modulation, and superpose the high frequency audio and the audio of the preset interaction time period of the video content; when the display device plays the video content at the preset interaction time period, the terminal equipment collects the high frequency audio and demodulates the code of the corresponding interaction content identity, and the interaction content corresponding to the code is matched through a background server; the terminal equipment receives and displays the interaction content, and transfers the interaction content from the display device responsible for video playing to the terminal equipment, so that the playing of the video content is not distracted, and is more participatory and interesting.

FIG. 1 is a method for cross-screen interaction of the embodiments of the present disclosure the applied to a server, wherein the method includes the following steps at an electronic device.

In step S101, coding and modulation is performed on an interaction content identity to generate a first audio signal imperceptible to human hearing.

Herein, the first audio signal is a high frequency audio signal which cannot be heard by humankind, and the frequency thereof is higher than 20 KHz. A server device performs coding and modulation on different interaction content identities respectively to generate a corresponding first audio signal for each interaction content identity. For example, technologies like amplitude shift keying (ASK), frequency shift keying (FSK), and phase shift keying (PSK) may be employed to complete the coding and modulation.

In step S102, the first audio signal is superposed with a second audio signal of a video content, and the video content with audio superposition is sent to a display device to play.

A preset interaction time period refers to a preset time period for generating interaction content at a play timeline of the video content, and the first audio signal is superposed into the second audio signal at the preset interaction time period.

In step S103, receiving the code of the interaction content identity sent after a terminal equipment detects the first audio signal, the interaction content corresponding to the code is sent to the terminal equipment, and the interaction content is displayed by the terminal equipment.

When the display device plays the video content with audio superposition at the preset interaction time period, and when the terminal equipment collects the first audio signal and demodulates the code of the corresponding interaction content identity, the server receives the code of the interaction content identity from the terminal equipment.

The server converts the received code into an interaction content identity in a character format through performing inverse operation of the code conversion in step S101. The corresponding interaction content is determined according to the interaction content identity and is sent to the terminal equipment to display.

Wherein, the interaction content includes but is not limited to voting, commenting, result guessing, game participation, questionnaire inquiry, advertisement information, or the like.

If the corresponding interaction content is matched according to the converted interaction content identity, then the server returns a message that the interaction content is matched and sends the interaction content to the terminal equipment, and the interaction content is displayed by the terminal equipment. If no corresponding interaction content is matched according to converted the interaction content identity, then the server returns a message that no interaction content is matched to the terminal equipment, while the terminal equipment will not respond to the message that no interaction content is matched, so that the user will not be distracted from enjoying the video content played by the display device.

In the embodiment, the server codes and modulates the interaction content identity into the first audio signal imperceptible to human hearing, and superposes the first audio signal at the preset interaction time period of the second audio signal. The server sends the video content with audio superposition to the display device to play. When the terminal equipment collects the first audio signal and demodulates the code of the interaction content identity, the server receives the code and converts it to the corresponding interaction content identity, and then sends the corresponding interaction content to the terminal equipment to display. During the foregoing process, the user will not perceive the first audio signal superposed at the preset interaction time period while viewing the video played by the display device. Therefore, the user's viewing will not be distracted; the server sends the interaction content to the terminal equipment, and the terminal equipment displays the interaction content, thus implementing the separation the interaction content from the video content, so that the interaction content will not occupy the resources of the display device and will not distract the appreciation of the user on the video content, which contributes to improving the will and motivation of the user's participating in the interaction, and is more participatory and interesting.

In one embodiment, step S101 further includes the following steps.

In step S1011, the interaction content identity is converted into an ASCII code from a character format, and then the ASCII code is converted into a corresponding binary code.

ASCII code (American Standard Code for Information Interchange) uses predefined 7-bit or 8-bit binary number to represent 128 or 256 possible characters. The standard ASCII code is also called as a basic ASCII code using 7-bit binary number to represent all capital and lowercase letters, 0 to 9, punctuation marks, and special control characters used in American English. Therefore, each character in the interaction content identity including the character format of numbers or letters may be converted into ASCII codes, and then the ASCII code is converted into a corresponding binary code.

In step S1012, the binary code is modulated into a first audio signal according with binary frequency shift keying.

Digital frequency modulation is also called as frequency shift keying (FSK), and binary frequency shift keying is recorded as 2 FSK. Frequency shift keying uses a carrier frequency to transmit digital messages, i.e., using the transmitted digital messages to control the carrier frequency. A 2 FSK signal is the modulated waveform of sign “1” corresponding to a carrier frequency f1 while a sign “0” corresponding to a carrier frequency f2 (another carrier frequency different from f1); moreover, the changing between f1 and f2 is completed instantaneously. The two carrier wave signals on different frequencies are used to transmit one binary information sequence. The advantages of frequency shift keying method are the fast converting speed, good waveform, high stability and ease implementation.

The binary information sequence corresponding to each character is modulated into a high frequency audio on a frequency higher than 20 KHz, and the high frequency audios corresponding to all the characters of one interaction content identity form the first audio signal.

In the embodiment, the interaction content identity in the character format is converted into a binary code, and is thus converted into the first audio signal imperceptible by human hearing using 2 FSK. Accordingly, in step S103, the code of the interaction content identity received from the server is a binary code acquired by the terminal equipment through demodulating the first audio signal using 2 FSK; the binary code corresponding to the code is converted into an ASCII code, and then the ASCII code is converted into an interaction content identity in a character format. The modulation and demodulation of the first audio signal are completed using binary frequency shift keying, so that the data conversion speed is fast, and the abilities for anti-noise and anti-attenuation are better.

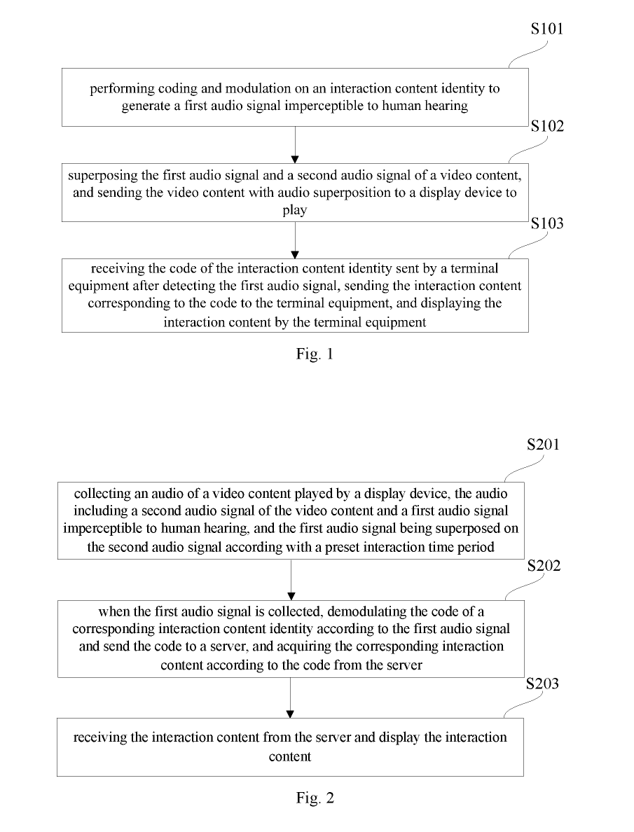

FIG. 2 is a method for cross-screen interaction of the embodiments of the present disclosure, which is applied to a terminal device, wherein the terminal device can be a mobile phone, a computer, a digital broadcast terminal, a messaging device, a gaming console, an on-vehicle console, a tablet device, a medical device, an exercise equipment, a personal digital assistant, or the like. As shown in FIG. 2, the method includes the following steps at an electronic device.

In step S201, an audio of a video content played by a display device is collected, the audio including a second audio signal of the video content and a first audio signal imperceptible to human hearing, and the first audio signal being superposed on the second audio signal according with a preset interaction time period.

The terminal equipment is locally equipped with a software development kit (SDK) capable of compiling a corresponding application to further process the collected audio.

In step S202, when the first audio signal is collected, the code of a corresponding interaction content identity is demodulated according to the first audio signal and send to a server, and the corresponding interaction content is acquired according to the code from the server.

A high-pass filter is invoked to acquire the first audio signal having a frequency higher than 20 KHz, and when the video content is played at the preset interaction time period, the first audio signal superposed on the second audio signal may be acquired.

A corresponding demodulator is invoked to demodulate the first audio signal to obtain the code of the corresponding interaction content identity.

Corresponding to the embodiment that the server modulates the code of the interaction content identity using binary frequency shift keying, the terminal equipment modulates the collected first audio signal using binary frequency shift keying accordingly at this moment to obtain a binary code corresponding to the code of the interaction content identity and send the binary code to the server.

In step S203, the interaction content is received from the server and displayed.

The terminal equipment after sending the modulated code to the server, starts monitoring a message returned from the server. When monitoring a message returned from the server that the interaction content is matched, the interaction content from the server is received and displayed; when monitoring a message that no interaction content is matched, the message returned from the server is monitored continuously.

The interaction content corresponding to the code displayed and demodulated by the terminal equipment includes but is not limited to voting, commenting, result guessing, game participation, questionnaire inquiry, advertisement information, or the like.

In the embodiment, the terminal equipment collects the audio when the display device is playing the video, acquires the first audio signal that cannot be perceived by the user at the preset interaction time period, demodulates the code of the corresponding interaction content identity and sends the code to the server, and receives and displays the interaction content returned from the server. The embodiment implements the separation the interaction content from the video content, so that the interaction content will not occupy the resources of the display device and will not distract the appreciation of the user on the video content, which contributes to improving the will and motivation of the user's participating in the interaction, and is more participatory and interesting.

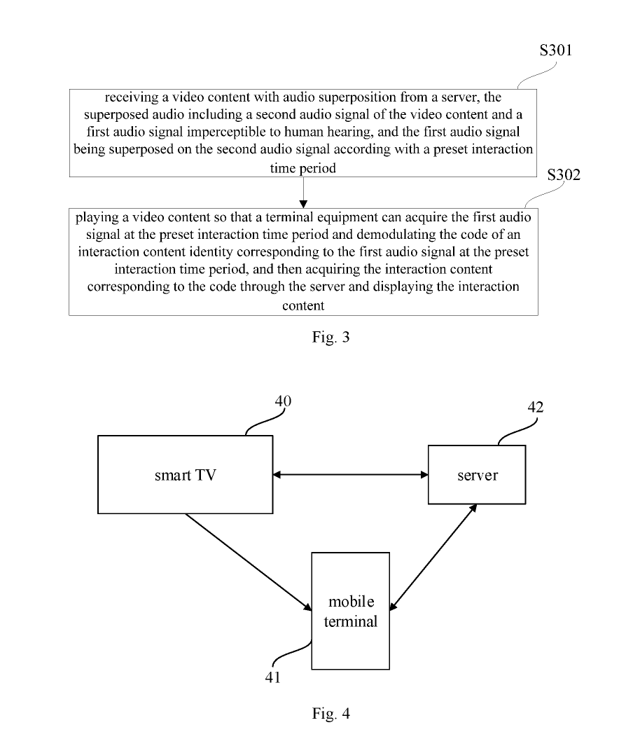

FIG. 3 is a method for cross-screen interaction of the embodiments of the present disclosure, which is applied to a display device, wherein the display device can be a smart TV, a smartphone, a computer, a digital broadcast terminal, a messaging device, a gaming console, an on-vehicle console, a tablet device, or the like. As shown in FIG. 3, the method includes the following steps.

In step S301, a video content with audio superposition is received from a server, the superposed audio including a second audio signal of the video content and a first audio signal imperceptible to human hearing, and the first audio signal being superposed on the second audio signal according with a preset interaction time period.

In step S302, a video content is played so that the terminal equipment can acquire the first audio signal at the preset interaction time period and demodulate the code of an interaction content identity corresponding to the first audio signal at the preset interaction time period, and then acquire the interaction content corresponding to the code through the server and display the interaction content.

In the embodiment, the video content played by the display device includes the first audio signal that cannot be perceived by the user at the preset interaction time period, while if the first audio signal is collected and modulated by the application program in user's terminal equipment, and can acquire the corresponding interaction content from the server, so that the interaction content is displayed in the terminal equipment. The user does not know the preset interaction time period, and will not perceive the first audio signal; therefore, the user will not be distracted to view the video content, and the interaction content corresponding to the first audio signal is transferred to the terminal equipment to display, thus implementing the separation the interaction content from the video content, so that the interaction content will not occupy the resources of the display device and will not distract the appreciation of the user on the video content, which contributes to improving the will and motivation of the user's participating in the interaction, and is more participatory and interesting.

The method for cross-screen interaction of the embodiments of the present disclosure is further explained hereinafter through an application scenario.

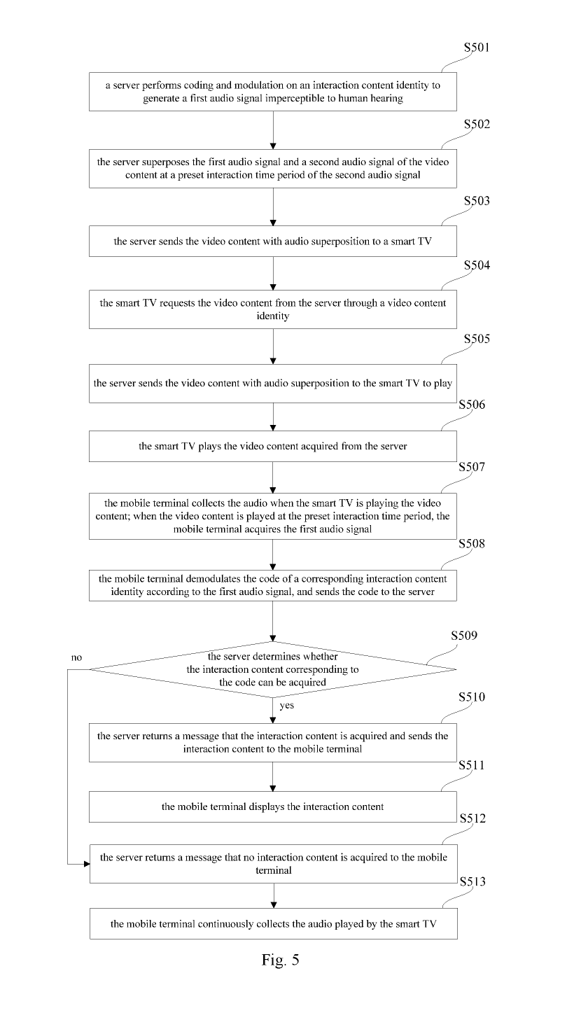

A system for cross-screen interaction as shown in FIG. 4 includes a smart TV 40, a mobile terminal 41 and a sever 42. The smart TV 40 and the mobile terminal 41 are communicated and connected to the server 42 respectively. The mobile terminal 41 collects an audio when the smart TV 40 is playing a video content, and processes the collected audio through an installed application program. As shown in FIG. 5, a method for cross-screen interaction implemented by the system for cross-screen interaction includes the following steps.

In step S501, the server 42 performs coding and modulation on an interaction content identity to generate a first audio signal imperceptible to human hearing.

For example, an identity “001” in a character format represents “advertisement 1”, the identity is converted into an ASCII code format from a character format to acquire the ASCII code form of the identity, for example, the ASCII code of the character “001” is “30 30 31”. Then the identity is converted into a binary code form from the ASCII code format, and the binary code form of the identity is acquired, for example, the binary code of “30 30 31” is “00110000 00110000 00110001”. By using 2 FSK, three binary digit sequences in the binary code are respectively coded into audios with frequencies which are different from each other and higher than 20 KHz , so as to form the first audio signal.

In step S502, the server 42 superposes the first audio signal and a second audio signal of the video content at a preset interaction time period of the second audio signal.

For example, the preset interaction time period is from 15th minute 30th second to 40th second of the video content, and the first audio signal is superposed to the 15th minute 30th second to 40th second of the second audio signal through audio coding and decoding.

In step S503, the server 42 sends the video content with audio superposition to the smart TV 40.

In step S504, the smart TV 40 requests the video content from the server 42 according to a video content identity, for example, requests the video content from the server 42 according to identity information such as video content name, frequency channel number, or the like.

In step S505, the server 42 sends the corresponding video content with audio superposition to the smart TV 40 to play.

In step S506, the smart TV 40 plays the video content acquired from the server 42.

In step S507, the mobile terminal 41 collects the audio when the smart TV 40 is playing the video content; when the video content is played at the preset interaction time period, the mobile terminal 41 acquires the first audio signal.

For example, when the video content is played to 15th minute 30th second to 40th second, the mobile terminal 41 acquires the first audio signal through a high-pass filter.

In step S508, the mobile terminal 41 demodulates the code of a corresponding interaction content identity according to the first audio signal, and sends the code to the server 42.

For example, the mobile terminal 41 demodulates 2 FSK signals to obtain a binary code “00110000 00110000 00110001”, and sends the binary code to the server 42.

In step S509, the server 42 determines whether the interaction content corresponding to the code can be acquired. When the server 42 acquires the interaction content corresponding to the code, step S510 is performed; and when the server 42 does not acquire the interaction content corresponding to the code, step S512 is performed.

For example, the server 42 converts the binary code “00110000 00110000 00110001” into a corresponding ASCII code “30 30 31”, and then further converts the ASCII code into an identity “001” in a character format so as to determine whether an interaction content corresponding to the identity can be matched.

In step S510, the server 42 returns a message that the interaction content is acquired and sends the interaction content to the mobile terminal 41.

For example, an “advertisement 1” corresponding to the identity “001” is matched by the server 42, then the server sends “advertisement 1” to the mobile terminal 41.

In step S511, the mobile terminal 41 displays the interaction content.

The mobile terminal 41 plays the “advertisement 1”.

In step S512, the server 42 returns a message that no interaction content is acquired to the mobile terminal 41.

In step S513, the mobile terminal 41 continuously collects the audio played by the smart TV 40.

In the foregoing application scenario, the interaction content is not limited to advertisement, but may also be voting, commenting, result guessing, game participation, questionnaire inquiry, or the like.

In the foregoing application scenario, the interaction content is transferred from the smart TV 40 to the mobile terminal 41 to display, thus implementing cross-screen display of the interaction content, so that the interaction content will not occupy the resources of the smart TV 40 and will not distract the appreciation of the user on the video content, which contributes to improving the will and motivation of the user's participating in the interaction.

Embodiments of devices of the present disclosure are described hereinafter, which may be used for performing the foregoing method according to the embodiments of the present disclosure.

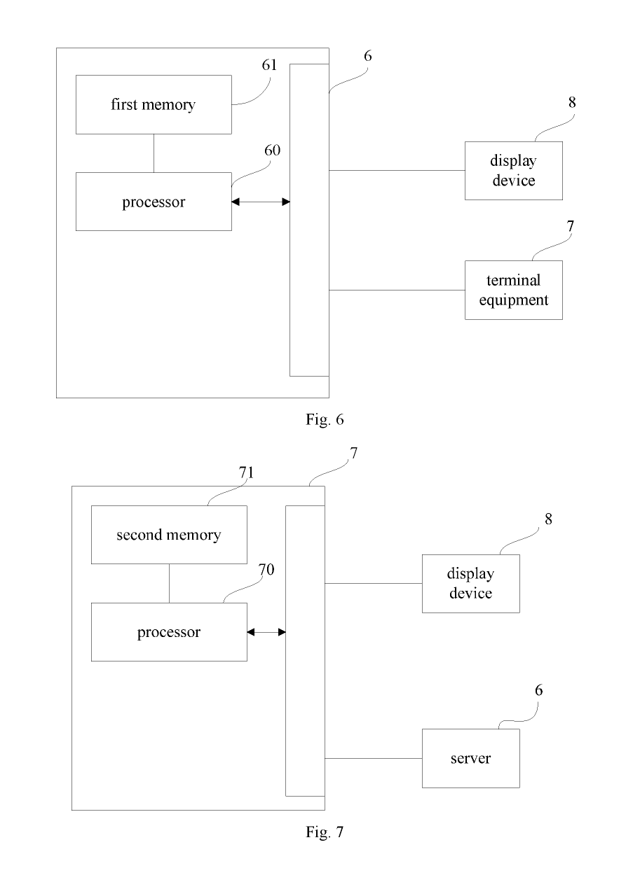

FIG. 6 is a block diagram of a device for cross-screen interaction of the embodiments of the present disclosure, which locates at a server 6 side. The device includes one or more processors 60; a first memory 61 configured to store instructions which is executable for the one or more processors 60;

wherein, the one or more processors 60 are configured to: perform coding and modulation on an interaction content identity to generate a first audio signal imperceptible to human hearing;

superpose the first audio signal and a second audio signal of a video content, and send the video content with audio superposition to a display device to play; and

receive the code of the interaction content identity sent by a terminal equipment after detecting the first audio signal, send the interaction content corresponding to the code to the terminal equipment, and display the interaction content by the terminal equipment.

In one embodiment, the one or more processors 60 are further configured to:

convert the interaction content identity from a character format into ASCII codes, and then convert the ASCII codes into a corresponding binary code; and

modulate the binary code into a first audio signal according with binary frequency shift keying.

In one embodiment, the one or more processors 60 are configured to:

convert the code into ASCII codes, and then convert the ASCII codes into an interaction content identity in a character format;

determine whether the interaction content identity is matched with a corresponding interaction content;

when the interaction content identity is matched with a corresponding interaction content, return a message that the interaction content is matched and send the interaction content to the terminal equipment 7; and

when no interaction content is corresponding to the interaction content identity, return a message that no interaction content is matched and send the interaction content to the terminal equipment 7.

FIG. 7 is a block diagram of a device for cross-screen interaction of the embodiments of the present disclosure, which locates at a terminal equipment 7 side. The device includes one or more processors 70; a second memory 71 configured to store instructions which is executable for the one or more processors 70;

wherein, the one or more processors 60 are configured to: collect an audio of a video content played by a display device 8, the audio including a second audio signal of the video content and a first audio signal imperceptible to human hearing, and the first audio signal being superposed on the second audio signal according with a preset interaction time period;

when the first audio signal in the audio is acquired, demodulate the code of a corresponding interaction content identity according to the first audio signal and send the code to a server, and acquire the corresponding interaction content according to the code from the server; and

receive the interaction content from the server 6 and display the interaction content.

In one embodiment, the one or more processors 70 are further configured to:

demodulate the first audio signal into a binary code through binary frequency shift keying; and

send the binary code to the server 6.

In one embodiment, the one or more processors 70 are further configured to:

monitor a message returned from the server 6; and

when monitoring a message returned from the server 6 that the interaction content is matched, receive the interaction content from the server 6 and display the interaction content.

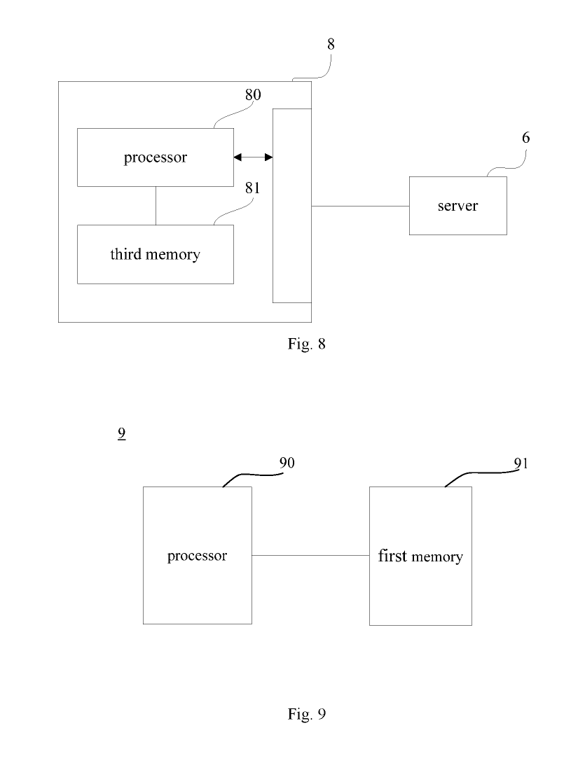

FIG. 8 is a block diagram of a device for cross-screen interaction of the embodiments of the present disclosure, which locates at a display device 8 side. The device includes one or more processors 80; and a third memory 81 configured to store instructions which is executable for the one or more processors 110;

wherein, the one or more processors 80 are configured to: receive the video content with audio superposition from the server 6, the superposed audio including a second audio signal of the video content and a first audio signal imperceptible to human hearing, and the first audio signal being superposed on the second audio signal according with a preset interaction time period; and

play a video content so that the terminal equipment 7 can acquire the first audio signal at the preset interaction time period and demodulate the code of an interaction content identity corresponding to the first audio signal, and acquire the interaction content corresponding to the code through the server 6 and display the interaction content.

Furthermore, each functional module above in the embodiments of the present disclosure can be implemented through a hardware processor.

FIG. 9 is a block diagram of a server of the embodiments of the present disclosure. The server 9 includes: one or more processors 90; a first memory 91 configured to store instructions which is executable for the one or more processors 90;

wherein, the one or more processors 90 are configured to: perform coding and modulation on an interaction content identity to generate a first audio signal imperceptible to human hearing; superpose the first audio signal and a second audio signal of a video content, and send the video content with audio superposition to a display device to play; and receive the code of the interaction content identity sent by a terminal equipment after detecting the first audio signal, send the interaction content corresponding to the code to the terminal equipment, and display the interaction content by the terminal equipment.

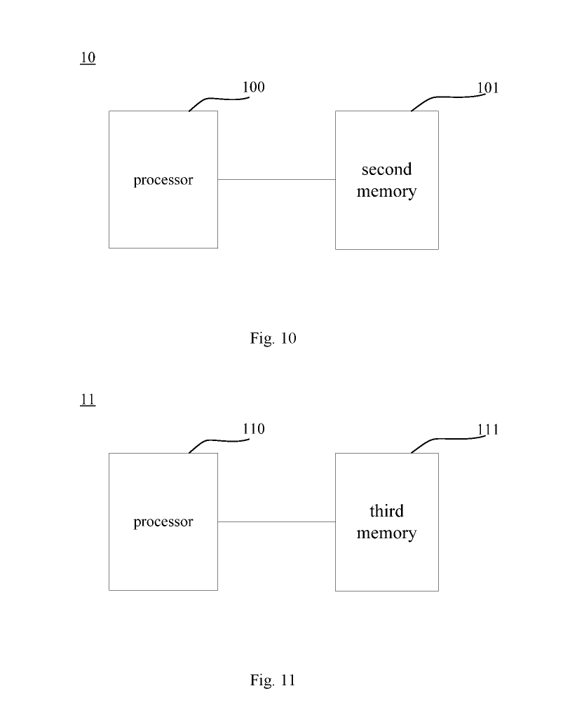

FIG. 10 is a block diagram of a terminal equipment of the embodiments of the present disclosure. The terminal equipment 10 includes one or more processors 100; and a second memory 101 configured to store instructions which is executable for the one or more processors 100;

wherein, the one or more processors 100 is configured to: collect an audio of a video content played by a display device, the audio including a second audio signal of the video content and a first audio signal imperceptible to human hearing; when the first audio signal is collected, demodulate the code of a corresponding interaction content identity according to the first audio signal and sending the code to a server, and acquire the corresponding interaction content according to the code from the server; and receive the interaction content from the server and display the interaction content.

FIG. 11 is a block diagram of a terminal equipment of the embodiments of the present disclosure. The a display device 11 includes one or more processors 110; and a third memory 111 configured to store instructions which is executable for the one or more processors 110;

wherein, the one or more processors 110 are configured to: receive a video content with audio superposition from a server, the superposed audio including a second audio signal of the video content and a first audio signal imperceptible to human hearing, and the first audio signal being superposed on the second audio signal according with a preset interaction time period; play the video content so that the terminal equipment can acquire the first audio signal at the preset interaction time period and demodulate the code of an interaction content identity corresponding to the first audio signal, and acquire the interaction content corresponding to the code through the server 6 and display the interaction content.

The device embodiments described above are only exemplary, wherein the units illustrated as separation parts may either be or not physically separated, and the parts displayed as units may either be or not physical units, i.e., the parts may either be located in the same plate, or be distributed on a plurality of network units. A part or all of the modules may be selected according to an actual requirement to achieve the objectives of the solutions in the embodiments. Those having ordinary skills in the art may understand and implement without creative work.

Through the above description of the implementation manners, those skilled in the art may clearly understand that each implementation manner may be achieved in a manner of combining software and a necessary general hardware platform, and certainly may also be achieved by hardware. Based on such understanding, the foregoing technical solutions, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device and so on) to execute the method according to each embodiment or some parts of the embodiments.

It should be finally noted that the above embodiments are only configured to explain the technical solutions of the present disclosure, but are not intended to limit the present disclosure. Although the present disclosure has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

What is claimed is:

1. A method for cross-screen interaction, comprising:
at an electronic device:
performing coding and modulation on an interaction content identity to generate a first audio signal imperceptible to human hearing;
superposing the first audio signal and a second audio signal of a video content, and sending the video content with audio superposition to a display device to play; and
receiving the code of the interaction content identity sent by a terminal equipment after detecting the first audio signal, sending the interaction content corresponding to the code to the terminal equipment, and displaying the interaction content by the terminal equipment.

2. The method according to claim 1, wherein the sending the interaction content corresponding to the code to the terminal equipment, and the displaying the interaction content by the terminal equipment comprises:
converting the code into ASCII codes, and converting the ASCII codes into an interaction content identity in a character format;
determining whether the interaction content identity is matched with a corresponding interaction content;
when the interaction content identity is matched with a corresponding interaction content, returning a message that the interaction content is matched and sending the interaction content to the terminal equipment; and
when no interaction content is corresponding to the interaction content identity, returning a message that no interaction content is matched to the terminal equipment.

3. A method for cross-screen interaction, comprising:
at an electronic device:
collecting an audio of a video content played by a display device, the audio comprising a second audio signal of the video content and a first audio signal imperceptible to human hearing;
when the first audio signal is collected, demodulating the code of a corresponding interaction content identity according to the first audio signal and sending the code to a server, and acquiring the corresponding interaction content according to the code from the server; and
receiving the interaction content from the server and displaying the interaction content.

4. The method according to claim 3, wherein receiving the interaction content from the server and displaying the interaction content comprises:
monitoring a message returned from the server; and
when monitoring a message returned from the server that the interaction content is matched, receiving the interaction content from the server and displaying the interaction content.

5. A device for cross-screen interaction, comprising:
one or more processors; and
a first memory configured to store instructions which is executable for the one or more processors;
wherein, the one or more processors are configured to:
perform coding and modulation on an interaction content identity to generate a first audio signal imperceptible to human hearing;
superpose the first audio signal and a second audio signal of a video content, and send the video content with audio superposition to a display device to play; and
receive the code of the interaction content identity sent by a terminal equipment after detecting the first audio signal, send the interaction content corresponding to the code to the terminal equipment, and display the interaction content by the terminal equipment.

6. The device according to claim 5, wherein the one or more processors are further configured to:
convert the code into ASCII codes, and then convert the ASCII code into an interaction content identity in a character format;
determine whether the interaction content identity is matched with a corresponding interaction content;
when the interaction content identity is matched with a corresponding interaction content, return a message that the interaction content is matched and send the interaction content to the terminal equipment; and
when no interaction content is corresponding to the interaction content identity, return a message that no interaction content is matched to the terminal equipment.

7. A device for cross-screen interaction, comprising:
one or more processors; and
a second memory configured to store instructions which is executable for the one or more processors;
wherein, the one or more processors are configured to:
collect an audio of a video content played by a display device, the audio comprising a second audio signal of the video content and a first audio signal imperceptible to human hearing, and the first audio signal being superposed on the second audio signal according with a preset interaction time period;
when the first audio signal in the audio is acquired, demodulate the code of a corresponding interaction content identity according to the first audio signal and send the code to a server, and acquire the corresponding interaction content according to the code from the server; and
receive the interaction content from the server and display the interaction content.

8. The device according to claim 7, wherein the one or more processors are further configured to:
monitor a message returned from the server; and
when monitoring a message returned from the server that the interaction content is matched, receive the interaction content from the server and display the interaction content.

9. A server, comprising:
one or more processors; and
a first memory configured to store instructions which is executable for the one or more processors;
wherein, the one or more processors are configured to:
perform coding and modulation on an interaction content identity to generate a first audio signal imperceptible to human hearing; superpose the first audio signal and a second audio signal of a video content, and send the video content with audio superposition to a display device to play; and receive the code of the interaction content identity sent by a terminal equipment after detecting the first audio signal, send the interaction content corresponding to the code to the terminal equipment, and display the interaction content by the terminal equipment.

10. The server according to claim 9, wherein the one or more processors are further configured to: convert the code into ASCII codes, and converting the ASCII codes into an interaction content identity in a character format; determine whether the interaction content identity is matched with a corresponding interaction content; when the interaction content identity is matched with a corresponding interaction content, return a message that the interaction content is matched and send the interaction content to the terminal equipment; and when no interaction content is corresponding to the interaction content identity, return a message that no interaction content is matched to the terminal equipment.

11. A terminal equipment, comprising:
one or more processors; and
a second memory configured to store instructions which is executable for the one or more processors;
wherein, the one or more processors are configured to: collect an audio played by a display device while playing a video content, the audio comprising a second audio signal of the video content and a first audio signal imperceptible to human hearing; when the first audio signal is collected, demodulate the code of a corresponding interaction content identity according to the first audio signal and sending the code to a server, and acquire the corresponding interaction content according to the code from the server; and receive the interaction content from the server and display the interaction content.

12. The terminal equipment according to claim 11, wherein the one or more processors are further configured to: monitor a message returned from the server; and when monitoring a message returned from the server that the interaction content is matched, receive the interaction content from the server and display the interaction content.
